(19) United States
(12) Patent Application Publication
(10) Pub. No.: US 2013/0186715 A1
(43) Pub. Date: Jul. 25, 2013

(54) SEPARATOR PLATE FOR BRAKE ASSEMBLY

(71) Applicant: Christopher A. MONROE, Decatur, IL (US)

(72) Inventor: Christopher A. MONROE, Decatur, IL (US)

(21) Appl. No.: 13/355,999

(22) Filed: Jan. 23, 2012

(51) Int. Cl. F16D 55/40; F16D 65/12

(52) U.S. Cl. 188/71.5; 188/218 XL

(57) ABSTRACT

A separator plate for use in a brake assembly is disclosed. The separator plate may have a generally plate-like ring with an inner diameter, an outer diameter, and a thickness. The separator plate may also have a plurality of protrusions extending radially outward from a periphery of the generally plate-like ring. A thickness of the generally plate-like ring is about 3.5-3.9 mm.

### TECHNICAL FIELD

The present disclosure is directed to a separator plate and, more particularly, to a separator plate for a brake assembly.

### BACKGROUND

Machines, including wheel loaders, on and off-highway haul and vocational trucks, motor graders, and other types of heavy equipment generally include a mechanical transmission drivingly coupled to opposing traction devices by way of front and/or rear differentials and two substantially identical final drive assemblies (one located between each differential and an associated traction device). Each differential receives a power input from the transmission and produces two power outputs directed through the final drive assemblies to the traction devices. The final drive assemblies function to reduce a rotational speed of the differential output to a level appropriate to drive the associated traction devices and thereby propel the machine.

Each final drive assembly generally includes a stationary housing, an axle rotatably disposed within the housing and driven by the differential, and a brake assembly connected between the housing and the axle. Typical brake assemblies include a plurality of friction plates connected to rotate with the axle, a plurality of separator plates disposed between adjacent friction plates and rotationally constrained at their periphery by the housing, and a piston configured to push the friction plates and separator plates together, thereby generating frictional torque between the plates that retards rotation of the axle. An example of this type of arrangement is described in U.S. Pat. No. 6,766,886 issued to Bendtsen et al. on Jul. 27, 2004.

### SUMMARY

One aspect of the present disclosure is directed to a separator plate. The separator plate may include a generally plate-like ring having an inner diameter, an outer diameter, and a thickness. The separator plate may also include a plurality of protrusions extending radially outward from a periphery of the generally plate-like ring. A thickness of the generally plate-like ring is about 3.5-3.9 mm.

Another aspect of the present disclosure is directed to a brake assembly. The brake assembly may include a reaction member, a plurality of friction plates, and at least one separator plate disposed between the plurality of friction plates. The at least one separator plate may have a thickness about 35% greater than a thickness of each of the plurality of friction plates. The brake assembly may also include a first piston selectively movable towards the reaction member by pressurized fluid to compress the plurality of friction plates and the at least one separator plate.

An additional aspect of the present disclosure is directed to a final drive. The final drive may include a housing, and an output member passing through the housing to engage a traction device. The final drive may also include a reaction member, a plurality of friction plates rotationally connected to the output member at an interior periphery, and a plurality of separator plates connected to the housing at an outer periphery and axially disposed between the plurality of friction plates. One more of the plurality of separator plates may have a thickness of about 3.5-3.9 mm. The final drive may further include a first piston selectively movable towards the reaction member by pressurized fluid to compress the plurality of friction plates and the plurality of separator plates, a second piston, a first spring configured to urge the second piston toward the first piston to compress the plurality of friction plates and the plurality of separator plates, and a second spring disposed within the first spring and configured to urge the second piston toward the first piston.

### BRIEF DESCRIPTION OF THE DRAWINGS

FIG. 1 is a pictorial illustration of an exemplary disclosed machine;

FIG. 2 is a cutaway illustration of an exemplary disclosed final drive that can be utilized in conjunction with the machine of FIG. 1;

FIG. 3 is an enlarged cross-sectional illustration of the a portion of the final drive of FIG. 2;

FIG. 4 is a side-view illustration of an exemplary disclosed separator plate that may be used in conjunction with the final drive of FIGS. 2 and 3; and

FIG. 5 is a front-view illustration of the separator plate of FIG. 4.

### DETAILED DESCRIPTION

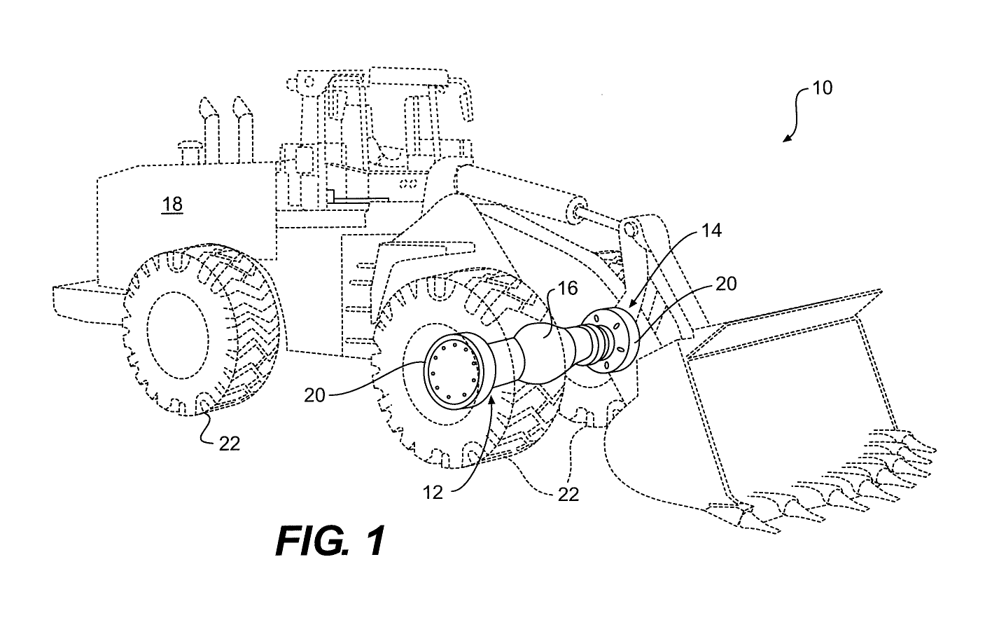

FIG. 1 illustrates an exemplary mobile machine 10 having left and right final drives 12, 14 coupled to each other by way of a differential 16. An input member, such as a driveshaft (not shown), may drivingly connect an engine 18 of machine 10 to differential 16, and an output member 20 may drivingly connect final drives 12, 14 to traction devices 22 located on opposing sides of machine 10. In one embodiment, traction devices 22 may be wheels, although other types of traction devices 22 may alternatively be utilized. Final drives 12, 14, may be drivingly coupled to differential 16 such that a rotation of the input member results in a corresponding rotation of traction devices 22.

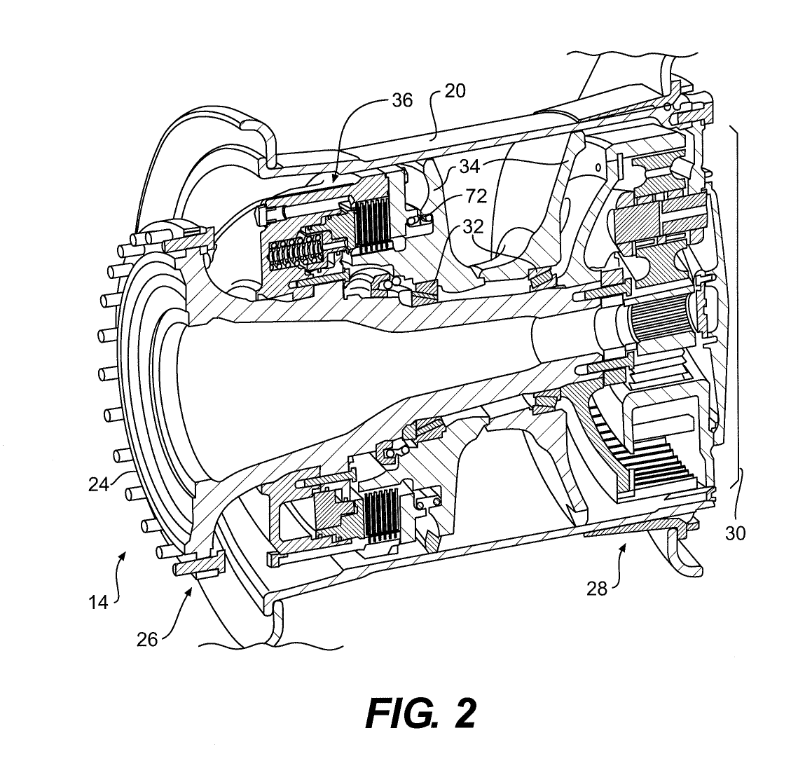

Right final drive 14, as illustrated in FIG. 2, may include an internal housing 24 configured to engage a stationary body of machine 10 (e.g., a housing of differential 16) at a first end 26 and support at an opposing end 28 a planetary gear arrangement 30. Planetary gear arrangement 30 may be driven by differential 16 via an axle (not shown) that passes through a center of internal housing 24. One or more bearings 32 may be spaced apart along an outside of internal housing 24 to support rotation of output member 20 via a pair of radially-extending webs 34. In this arrangement, webs 34 and output member 20 may be rigidly connected to rotate together about internal housing 24. Output member 20 may be driven by differential 16 and speed-reduced by planetary gear arrangement 30. Although not shown in detail in the figures, it should be noted that left final drive 12 may be substantially identical to right final drive 14.

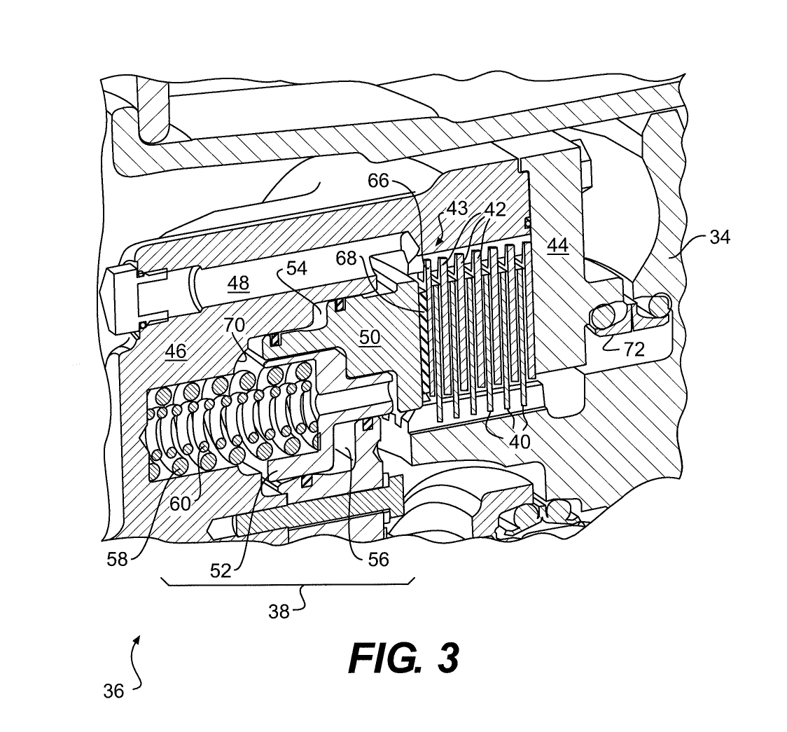

Referring to both FIGS. 2 and 3, right final drive 14 may be equipped with an internal brake assembly 36 configured to resist rotation of output member 20. Brake assembly 36 may include, among other things, an actuator 38, a plurality of friction plates 40, at least one separator plate 42 disposed between friction plates 40, a pressure plate 43 located at an inside end of friction plates 40, and a reaction member 44 located at an outside end of friction plates 40. Friction plates 40 may be connected to rotate with output member 20 (as will be explained in more detail below) and separator plate(s) 42 may be stationary such that, when actuator 38 is filled with pressurized fluid, friction plates 40 may be sandwiched between actuator 38, pressure plate 43, separator plate(s) 42, and reaction member 44, thereby creating frictional torque that resists rotation of output member 20. In this configuration, a pressure of fluid within actuator 38 may relate to a magnitude of the frictional torque resisting motion of output member 20. Actuator 38, friction plates 40, and separator plate(s) 42 may all be disposed within a toroidal brake housing 46, and reaction member 44 may close off an axial end of brake housing 46 such that brake housing 46, together with reaction member 44, substantially encloses the remaining components of brake assembly 36. A lubrication port 48 may be formed at least partially within brake housing 46 and configured to continuously supply oil to brake assembly 36 for lubrication purposes.

Actuator 38 may include a first piston 50 and a second piston 52 that work together to slow or stop machine 10 under different conditions. An external annular surface of first piston 50, together with an internal annular surface of brake housing 46, may form a first control chamber 54. When first control chamber 54 is filled with oil pressurized to a maximum of about 825-875 psi, first piston 50 may be urged toward reaction member 44. At all times during operation of machine 10, the pressurized fluid may also be directed into a second control chamber 56 formed between an end surface of second piston 52 and a flange of internal housing 24 to urge second piston 52 away from first piston 50. First and second springs 58, 60 may be disposed between brake housing 46 and second piston 52 to bias second piston 52 toward first piston 50. In the disclosed embodiment, first spring 58 may be configured to exert a force on second piston 52 that is about 4-5 times greater than a force exerted on second piston 52 by second spring 60. When pressurized fluid is not supplied into second control chamber 56, for example when machine 10 is turned off, second piston 56 may be biased into engagement with first piston 50 to compress friction and separator plates 40, 42, thereby providing braking of traction devices 22 when machine 10 is parked. The design and use of first and second springs 58, 60 together may provide a required total biasing force, while also providing desired response characteristics of second piston 52 that may not be possible with a single spring.

Each friction plate 40 may include a generally plate-like ring having a plurality of inwardly extending protrusions (e.g., gear teeth) that are configured to engage corresponding geometry (e.g., a spline) of a rotating component associated with output member 20 such that friction plates 40 rotate together with output member 20. In the disclosed embodiment, friction plates 40 are configured to engage a portion of an inner-most web 34 (i.e., the web 34 located closest to first end 26 of internal housing 24) that is connected to output member 20. It is contemplated, however, that friction plates 40 may alternatively engage another component associated with output member 20, if desired. Each friction plate 40 may be fabricated as a single integral component from metal, for example from steel, and be provided with a coating and/or a roughened texture (e.g., intersecting grooves) at axial surfaces thereof to increase a coefficient of friction of friction plates 40. Brake assembly 36 illustrated in FIGS. 2 and 3 includes six substantially identical friction plates 40 each having a thickness of about 2.5-3.0 mm, an inner radius of about 410-440 mm, and an outer radius of about 520-560 mm. Friction plates 40 may be separated from each other and from reaction member 44 by separator plates 42.

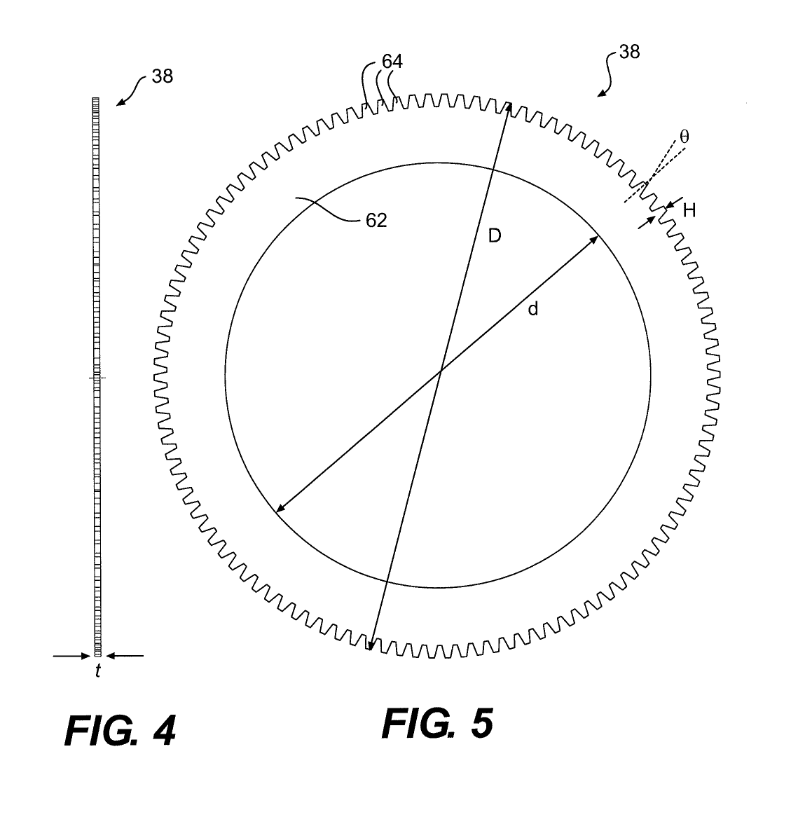

Separator plates 42, as shown in FIGS. 4 and 5, may also include a generally plate-like ring 62 and a plurality of outwardly extending protrusions 64 (e.g., gear teeth) that are configured to engage corresponding geometry (e.g., inwardly extending gear teeth) of a stationary component associated with internal housing 24. In the disclosed embodiment, separator plates 42 are configured to engage a portion of brake housing 46 that is mechanically fastened to internal housing 24. It is contemplated, however, that separator plates 42 may alternatively engage another component associated with internal housing 24, if desired. Each separator plate 42 may be fabricated as a single integral component from metal, for example from wrought steel. Brake assembly 36 illustrated in FIGS. 2 and 3 includes six substantially identical separator plates 42 each having a thickness t of about 3.5-3.9 mm (preferably about 3.65-3.75 mm), an inner diameter d of about 415-435 mm (preferably about 425-430 mm), and an outer diameter D of about 525-565 mm (preferably about 540-545 mm). Accordingly, a thickness of separator plates 42 (e.g., of both ring 62 and protrusions 64) may be about 25-50% greater than a thickness of friction plates 40 (preferably about 35% greater), such that each separator plate 42 may function as a heat sink and absorb heat generated by the sliding interaction with adjacent friction plates 40. In an exemplary embodiment, each separator plate 42 may be provided with 110 protrusions 64, each having a height H of about 15-30 mm (preferably about 20-25 mm) and a pressure angle θ of about 14.5°. A part (e.g., protrusions 64) or all of each separator plate 42 may be hardened to a Rockwell hardness of about 20-35 C.

Pressure plate 43 may be an assembly of at least two components, including a plate 66 and a damper 68 that is connected to plate 66. Plate 66 may be fabricated from material and/or have geometry similar to separator plates 42 (i.e., plate 66 may include a plate-like ring and outwardly extending protrusions that are fabricated from wrought steel), with the same or different dimensions. For example, plate 66 may be thinner than separator plates 42. Damper 68 may include a plate-like ring of polymer (e.g., rubber) that is bonded or otherwise fastened to plate 66 on a side of plate 66 adjacent first piston 50 (i.e., opposite the adjacent friction plate 40). Damper 68 may be configured to dampen vibrations within brake assembly 36.

Reaction member 44 may be a stationary member that is operatively coupled to internal housing 24. In particular, reaction member 44 may be rigidly connected to an end of brake housing 46 to close off a recess 70 within brake housing 46 that contains the remaining components of brake assembly 36. Brake housing 46, in turn, may be rigidly connected to internal housing 24 at first end 26, such that brake housing 46 and reaction member 44 are held stationary together with internal housing 24. In this configuration, reaction member 44 may function as an end stop for first and second pistons 50, 52 such that, when first and/or second pistons 50, 52 push against pressure plate 43 by pressurized fluid, reaction member 44 may create an opposing force that effectively sandwiches friction and separator plates 40, 42 therebetween. A seal 72 may be disposed between reaction member 44 and web 34 to help seal a sliding interface between the rotating and stationary components of brake assembly 36.

### INDUSTRIAL APPLICABILITY

The separator plates of the present disclosure may be applicable to any brake assembly where longevity of the assembly is desired. The disclosed separator plates may provide for longevity of the brake assembly through novel geometry and/or dimensions that allows the separator plates to act as heat sinks, absorbing heat from adjacent friction plates.

It has been determined that the life of a brake assembly can be shortened when components of the assembly overheat. For example, when friction and/or separator plates of the brake assembly overheat, these plates can warp, thereby rendering the brake inoperable and/or causing further damage to the assembly. Conventional wisdom might direct focus to methods of cooling the brake assembly, through use of high-flow oil baths and/or circulated coolant within the assembly. These pursuits, however, could result in overly complicated and expensive systems, with reduced durability. Accordingly, the present disclosure addresses issues of overheating through the use of separator plates 42, which are designed to function as heat sinks for adjacent components (i.e., for friction plates 40). Specifically, because separator plates 42 may be significantly thicker than adjacent friction plates 40, separator plates 42 may be capable of absorbing a greater amount of heat generated during a braking operation. In fact, the disclosed thickness of separator plates 42, in combination with the other disclosed dimensions of separator plates 42 and/or friction plates 40, was selected to provide a desired amount of heat absorption for large construction equipment applications. This capability may help reduce the likelihood of warping within brake assembly 36 caused by overheating, thereby increasing longevity of brake assembly 36.

To activate brake assembly 36, an operator of machine 10 may manipulate an interface device (not shown) located within machine 10. For example, the operator of machine 10 may depress a brake pedal (not shown). In response to manipulation of the interface device, oil may be pressurized and directed into first control chamber 54 of brake assembly 36, thereby causing first piston 50 to push pressure plate 43 toward reaction member 44 and compress friction and separator plates 40, 42. As rotating friction plates 40 are pressed against stationary separator plates 42, frictional torque may be generated between the components that results both in the slowing of friction plates 40 and connected output member 20 and in the generation of heat. The heat generated during braking may be absorbed by the mass of material contained within separator plates 42.

Any time machine 10 is operational, pressurized fluid may be directed into second control chamber 56. This pressurized fluid may urge second piston 52 to move away from first piston 50 and compress first and second springs 58, 60. When second piston 52 is moved away from first piston 50, output member 20 may he relatively free to rotate, unless acted on by first piston 50. When machine 10 is turned off, the flow of pressurized fluid into second control chamber 56 may be terminated, allowing first and second springs 58, 60 to return second piston 52 back into contact with first piston 50. The force of second piston 52 on first piston 50 that is generated by first and second springs 58, 60 may cause compression of friction and separator plates 40, 42 such that rotation of output member 20 may be hindered and/or stopped completely even when first control chamber 56 is not filled with pressurized fluid. In this manner, second piston 52 may provide park brake functionality.

It will be apparent to those skilled in the art that various modifications and variations can be made to the separator plate and brake assembly of the present disclosure without departing from the scope of the disclosure. Other embodiments will be apparent to those skilled in the art from consideration of the specification and practice of the separator plate and brake assembly disclosed herein. It is intended that the specification and examples be considered as exemplary only, with a true scope of the disclosure being indicated by the following claims and their equivalents.

What is claimed is:

1. A separator plate for a brake assembly, comprising:
a generally plate-like ring having an inner diameter, an outer diameter, and a thickness; and
a plurality of protrusions extending radially outward from a periphery of the generally plate-like ring,
wherein a thickness of the generally plate-like ring is about 3.5-3.9 mm.

2. The separator plate of claim 1, wherein the thickness is about 3.65-3.75 mm.

3. The separator plate of claim 1, wherein the outer diameter is about 525-565 mm.

4. The separator plate of claim 3, wherein the outer diameter is about 540-545 mm.

5. The separator plate of claim 3, wherein the inner diameter is about 415-435 mm.

6. The separator plate of claim 5, wherein the inner diameter is about 425-430 mm.

7. The separator plate of claim 5, wherein a height of each of the plurality of protrusions is about 15-30 mm.

8. The separator plate of claim 7, wherein the height is about 20-25 mm.

9. The separator plate of claim 1, wherein the plurality of protrusions are spaced substantially equidistant from each other and a thickness of each of the plurality of protrusions is about the same as the thickness of the generally plate-like ring.

10. The separator plate of claim 1, wherein each of the protrusions forms a gear tooth.

11. The separator plate of claim 10, wherein:
a number of gear teeth disposed around the periphery of the generally plate-like ring is 110; and
each of the gear teeth has a pressure angle of about 14.5°.

12. The separator plate of claim 1, wherein the generally plate-like ring and the plurality of protrusions are fabricated as a single component from wrought steel.

13. The separator plate of claim 1, wherein the generally plate-like ring and the plurality of protrusions have a Rockwell hardness of about 20-35 C.

14. A brake assembly, comprising:
a reaction member;
a plurality of friction plates;
at least one separator plate disposed between the plurality of friction plates and having a thickness about 35% greater than a thickness of each of the plurality of friction plates; and
a first piston selectively movable towards the reaction member by pressurized fluid to compress the plurality of friction plates and the at least one separator plate.

15. The brake assembly of claim 14, wherein the thickness of the at least one separator plate is about 3.5-3.9 mm.

16. The brake assembly of claim 14, wherein a maximum pressure of the pressurized fluid used to move the first piston towards the reaction member is about 825-875 psi.

17. The brake assembly of claim 14, further including:
a second piston;
a first spring configured to urge the second piston toward the first piston to compress the plurality of friction plates and the at least one separator plate; and
a second spring disposed within the first spring and configured to urge the second piston toward the first piston, wherein the second piston is held away from the first piston by pressurized fluid during operation of the brake assembly.

18. The brake assembly of claim 17, wherein the first spring exerts about 4-5 times as much force on the second piston as is exerted by the second spring on the second piston.

19. The brake assembly of claim 14, wherein the plurality of friction plates and the at least one separator plate are continuously lubricated during operation.

20. A final drive, comprising:
a housing;
an output member passing through the housing to engage a traction device;
a reaction member;
a plurality of friction plates rotationally connected to the output member at an interior periphery;
a plurality of separator plates connected to the housing at an outer periphery, axially disposed between the plurality of friction plates, one or more of the plurality of separator plates having a thickness of about 3.5-3.9 mm;
a first piston selectively movable towards the reaction member by pressurized fluid to compress the plurality of friction plates and the plurality of separator plates;
a second piston;
a first spring configured to urge the second piston toward the first piston to compress the plurality of friction plates and the plurality of separator plates; and
a second spring disposed within the first spring and configured to urge the second piston toward the first piston.
